(19) United States
(12) Patent Application Publication
(10) Pub. No.: US 2016/0104096 A1
(43) Pub. Date: Apr. 14, 2016

(54) MATCHING SHORT-TERM STAFFING ASSIGNMENTS BASED ON PREVIOUS EMPLOYEE AND EMPLOYER RATINGS AND A REAL-TIME LIVE INTERVIEW

(71) Applicant: STAFFLY, INC., San Francisco, CA (US)

(72) Inventors: Joseph Bjorn OVICK, San Francisco, CA (US); Monica Marissa OVICK, San Francisco, CA (US); Michael HOGAN, Oxnard, CA (US)

(21) Appl. No.: 14/511,869

(22) Filed: Oct. 10, 2014

(51) Int. Cl. G06Q 10/06

(52) U.S. Cl. CPC G06Q 10/063112

(57) ABSTRACT

Described are platforms, systems, media, and methods for providing an on-demand temporary staffing exchange. Automatic identification of individual staffers suitable for particular temporary staffing positions is based in part on ratings of the individual staffer and of the employer. When a suitable individual is identified, immediate booking is effectuated.

### BACKGROUND OF THE INVENTION

Absenteeism is a major issue for employers, particularly in the retail space. The unexpected absence rate for hourly employees is about 5.5 days per year, which is compared to about 10 days of scheduled absences, and are about 44% more expensive to cover through overtime. Recruiting new employees is not easy for employers. 60% of small businesses report that finding qualified candidates is their biggest human resources challenge. The median cost for small business to recruit a new employee is $3,665. Therefore, the gaps in staffing created by absenteeism often go unfilled.

### SUMMARY OF THE INVENTION

There is a need for an easy-to-use, on-demand market place for temporary staffing services that can efficiently fill these staffing gaps. Employers need pool of available people who meet a known set of qualifications. Individuals who want supplemental or part-time income need a simple place to find part-time work. Existing tools are intended for full-time employment applications and are inadequate to address the unique challenges of temporary staffing.

Temporary staffing needs are rather significant in many different fields. For example, a restaurant may need a replacement waiter on short notice if an employee calls in sick. As another example, a grocery store may need a temporary cashier for a short period of time when one of its cashiers resigns. The number of openings for temporary staffing can be significantly higher than full-time opportunities and sometimes associated with a much more frequent occurrence rate than full-time openings. Further, the need for temporary staffing is much less predictable than full-time employment demands. Due to this unpredictable nature, the number, the duty, or the start time of temporary staffing openings can be constantly changing. In addition, the temporary staffing needs are relatively urgent, i.e., on the scale of less than 1 to 72 hours.

Consequences flow with the aforementioned unique challenges of temporary staffing. First, the searching, matching, or booking of a temporary staff has to be carried out quickly. Thus, there is a need for a temporary staffing platform or system that is efficient and convenient to use during the entire hiring process. Further, such a staffing platform needs to enable a much faster hiring process than a traditional full-time hiring. As a result, there is a demand for direct digital communication between staffs and employers so that a single event of inquiry, messaging, interview, or hiring can be real-time and promptly expedite the hiring process.

Existing tools intended for full-time applications are inadequate as they are not designed to reflect fast-pace changes in the temporary staffing needs. Further, the applying-hiring process is labor and time consuming. An applicant goes through a lengthy process to fill-out details in the application form and is able to contact the employer directly, especially the personnel in charge of the hiring. Further, it is impossible for an employer to book, interview, or hire a qualified applicant immediately via existing job searching websites or tools. Furthermore, ratings, comments, or reviews of an employer or an employee based on one or more previous jobs may not be readily available or relevant for future searching, booking, matching, or hiring events.

Described herein are temporary staffing platforms, systems, and applications to match one or more qualified individuals to one or more temporary staffing openings for an employer. The present invention especially focuses on a pool of staff, employers, and temporary assignments. The present invention allows the hired temporary staff and the hiring employer to enter ratings, reviews, evaluations, or comments for each other based on one or more temporary staffing assignments. Such information provides helpful inputs in the searching, matching, or hiring process for future staffing needs, where temporary staffing assignments recur one or more times. The claimed invention also enables the employer to immediately book a matched individual based optionally on searches and automatic matching events. The present invention also enables directly communication between the employer and the matched staff using a temporary staffing platform, system, or application. For example, real-time notifications, in-application text, audio, or video chat, or in-application interviews are conveniently carried out between an employer and a potential staff within the staffing platform, system, or application. With the currently presented invention, profiling, rating, browsing of profiles, browsing of ratings, targeted searches, matching, booking, and hiring of temporary staffs are conveniently enabled within one temporary staffing platform, system, or application.

In one aspect, disclosed herein are temporary staffing platforms comprising: a processor configured to provide an individual staff application comprising: a database comprising a plurality of staff profiles, each staff profile associated with an individual and comprising work experience, picture, video, qualifications, billing rate, availability, and ratings by previous employers; a software module configured to provide an interface allowing the individual to rate employers who have previously hired them for temporary staffing assignments; a software module configured to provide a notification to the individual when they have been selected for a temporary staffing assignment; a processor configured to provide an employer application comprising: a database comprising a plurality of employer profiles, each employer profile comprising one or more descriptions of temporary staffing assignments, type of business, url, address, phone number, dress code for assignment, number of employees, owner name, supervisor, and ratings by individual staff previously employed; a software module configured to provide an interface allowing the employer to perform a targeted search for individuals suitable for a current temporary staffing assignment; a software module configured to automatically match one or more individuals to the current temporary staffing assignment based on experience, qualifications, billing rate, availability, ratings of the individual by previous employers, and ratings of previous employers by the individual; a software module configured to provide an interface allowing the employer to immediately book a matched individual, the booking generating a notification to the individual. In some embodiments, the individual ratings provided by previous employers each comprise a score. In further embodiments, a high score provided by a previous employer for an individual increases the probability for a match between the employer and the individual for a current temporary staffing assignment. In some embodiments, the employer ratings by provided by an individual previously employed each comprise a score. In further embodiments, a high score provided by an individual for a previous employer increases the probability for a match between the individual and the employer for a current temporary staffing assignment. In some embodiments, the software module configured to automatically match one or more individuals to the current temporary staffing assignment returns a prioritized list of matched individuals. In further embodiments, the prioritized list of matched individuals is based on one or more of: availability, billing rate, skills, location of assignment, and rating. In some embodiments, the notification comprises a response deadline. In further embodiments, if the notification is not responded to prior to the response deadline, a next individual is matched to the current temporary staffing assignment. In some embodiments, the response deadline is less than 1 day. In further embodiments, the response deadline is less than 12 hours, 6 hours, or 1 hour. In some embodiments, the current temporary staffing assignment comprises no more than 29 hours of work per week. In some embodiments, the employer application further comprises a software module configured to provide an interface allowing the employer to configure payment for temporary staffing assignments performed. In some embodiments, the employer application further comprises a software module configured to immediately schedule a web-based audio and video interview with a matched individual. In some embodiments, the individual staff application further comprises a software module configured to provide an interface allowing the individual to configure receipt of payment for temporary staffing assignments performed. In some embodiments, the software module configured to provide an interface allowing the employer to perform a targeted search for individuals provides predictive keyword suggestions. In some embodiments, the individual staff application comprises a mobile application. In further embodiments, the individual staff application further comprises a software module configured to provide an interface allowing the individual to obtain a supervisor signature at the end of an assignment documenting that the assignment is complete. In some embodiments, the employer application comprises a mobile application. In some embodiments, the individuals have cleared a background check.

In another aspect, disclosed herein are computer-implemented systems comprising: a digital processing device comprising an operating system configured to perform executable instructions and a memory; a computer program including instructions executable by the digital processing device to create an individual temporary staffing application comprising: a software module configured to provide an interface allowing an individual to create an individual staff profile, the individual staff profile comprising work experience, picture, video, qualifications, billing rate, and ratings by previous employers; a software module configured to provide an interface allowing the individual to indicate availability for temporary staffing assignments, the availability comprising available dates, and for each date, available times; a software module configured to provide an interface allowing the individual to rate employers who have previously hired them for a temporary staffing assignment; and a software module configured to: provide a notification to the individual when they have been selected for a current temporary staffing assignment; and receive a response to the notification from the individual, the response confirming an immediate booking for the current temporary staffing assignment; provided that the individual is automatically selected for the temporary staffing assignment based on experience, qualifications, billing rate, availability, ratings of the individual by previous employers, and ratings of previous employers by the individual. In some embodiments, the individual ratings provided by previous employers each comprise a score. In further embodiments, a high score provided by a previous employer for an individual increases the probability for a match between the employer and the individual for a current temporary staffing assignment. In some embodiments, the employer ratings by provided by an individual previously employed each comprise a score. In further embodiments, a high score provided by an individual for a previous employer increases the probability for a match between the individual and the employer for a current temporary staffing assignment. In some embodiments, the software module configured to automatically match one or more individuals to the current temporary staffing assignment returns a prioritized list of matched individuals. In some embodiments, the notification comprises a response deadline. In further embodiments, if the notification is not responded to prior to the response deadline, a next individual is matched to the current temporary staffing assignment. In some embodiments, the response deadline is less than 1 day. In further embodiments, the response deadline is less than 12 hours, 6 hours, or 1 hour. In some embodiments, the individual staff application further comprises a software module configured to provide an interface allowing the individual to configure receipt of payment for temporary staffing assignments performed. In some embodiments, the individual staff application comprises a mobile application. In further embodiments, the individual staff application further comprises a software module configured to provide an interface allowing the individual to obtain a supervisor signature at the end of an assignment documenting that the assignment is complete.

In another aspect, disclosed herein are non-transitory computer-readable storage media encoded with a computer program including instructions executable by a processor to create a individual temporary staffing application comprising: a software module configured to provide an interface allowing an individual to create an individual staff profile, the individual staff profile comprising work experience, picture, video, qualifications, billing rate, and ratings by previous employers; a software module configured to provide an interface allowing the individual to indicate availability for temporary staffing assignments, the availability comprising available dates, and for each date, available times; a software module configured to provide an interface allowing the individual to rate employers who have previously hired them for a temporary staffing assignment; and a software module configured to: provide a notification to the individual when they have been selected for a current temporary staffing assignment; and receive a response to the notification from the individual, the response confirming an immediate booking for the current temporary staffing assignment; provided that the individual is automatically selected for the temporary staffing assignment based on experience, qualifications, billing rate, availability, ratings of the individual by previous employers, and ratings of previous employers by the individual.

In another aspect, disclosed herein are computer-implemented systems comprising: a digital processing device comprising an operating system configured to perform executable instructions and a memory; a computer program including instructions executable by the digital processing device to create an employer temporary staffing application comprising: a software module configured to provide an interface allowing an employer to create an employer profile, the employer profile comprising one or more descriptions of temporary staffing assignments, type of business, url, address, phone number, dress code for assignment, number of employees, owner name, supervisor, and ratings by individual staff previously employed; a software module configured to provide an interface allowing the employer to rate individuals who have previously performed temporary staffing assignments; a software module configured to provide an interface allowing the employer to perform a targeted search for individuals suitable for a current temporary staffing assignment; a software module configured to automatically match one or more individuals to the current temporary staffing assignment based on individual experience, qualifications, billing rate, availability, ratings of the individual by previous employers, and ratings of previous employers by the individual; and a software module configured to provide an interface allowing the employer to immediately book a matched individual, the booking generating a notification to the individual. In some embodiments, the individual ratings provided by previous employers each comprise a score. In further embodiments, a high score provided by a previous employer for an individual increases the probability for a match between the employer and the individual for a current temporary staffing assignment. In some embodiments, the employer ratings by provided by an individual previously employed each comprise a score. In further embodiments, a high score provided by an individual for a previous employer increases the probability for a match between the individual and the employer for a current temporary staffing assignment. In some embodiments, the software module configured to automatically match one or more individuals to the current temporary staffing assignment returns a prioritized list of matched individuals. In some embodiments, the notification comprises a response deadline. In further embodiments, if the notification is not responded to prior to the response deadline, a next individual is matched to the current temporary staffing assignment. In some embodiments, the response deadline is less than 1 day. In further embodiments, the response deadline is less than 12 hours, 6 hours, or 1 hour. In some embodiments, the employer application further comprises a software module configured to provide an interface allowing the employer to configure payment for temporary staffing assignments performed. In some embodiments, the employer application further comprises a software module configured to immediately schedule a web-based audio and video interview with a matched individual. In some embodiments, the software module configured to provide an interface allowing the employer to perform a targeted search for individuals provides predictive keyword suggestions. In some embodiments, the employer application comprises a mobile application.

In another aspect, disclosed herein are non-transitory computer-readable storage media encoded with a computer program including instructions executable by a processor to create an employer temporary staffing application comprising: a software module configured to provide an interface allowing an employer to create an employer profile, the employer profile comprising one or more descriptions of temporary staffing assignments, type of business, url, address, phone number, dress code for assignment, number of employees, owner name, supervisor, and ratings by individual staff previously employed; a software module configured to provide an interface allowing the employer to rate individuals who have previously performed temporary staffing assignments; a software module configured to provide an interface allowing the employer to perform a targeted search for individuals suitable for a current temporary staffing assignment; a software module configured to automatically match one or more individuals to the current temporary staffing assignment based on individual experience, qualifications, billing rate, availability, ratings of the individual by previous employers, and ratings of previous employers by the individual; and a software module configured to provide an interface allowing the employer to immediately book a matched individual, the booking generating a notification to the individual.

In another aspect, disclosed herein are computer-implemented methods of booking an individual for a temporary staffing assignment comprising: storing, by a computer, an employer profile comprising ratings by individual staff previously employed for temporary staffing assignments by the employer; storing, by the computer, a plurality of individual staff profiles each comprising ratings of the individual by previous employers; receiving, by the computer, a request by the employer to fill a current temporary staffing assignment; matching, by the computer, one or more individuals to the current temporary staffing assignment based on individual experience, qualifications, billing rate, availability, ratings of the individual by previous employers, and ratings of previous employers by the individual; transmitting, by the computer, a notification to a matched individual when they have been matched to the current temporary staffing assignment; and receiving, by the computer, a response to the notification, the response triggering an immediate booking of the individual for the current temporary staffing assignment. In some embodiments, the individual ratings provided by previous employers each comprise a score. In further embodiments, a high score provided by a previous employer for an individual increases the probability for a match between the employer and the individual for a current temporary staffing assignment. In some embodiments, the employer ratings by provided by an individual previously employed each comprise a score. In further embodiments, a high score provided by an individual for a previous employer increases the probability for a match between the individual and the employer for a current temporary staffing assignment. In some embodiments, the software module configured to automatically match one or more individuals to the current temporary staffing assignment returns a prioritized list of matched individuals. In some embodiments, the notification comprises a response deadline. In further embodiments, if the notification is not responded to prior to the response deadline, a next individual is matched to the current temporary staffing assignment. In some embodiments, the response deadline is less than 1 day. In further embodiments, the response deadline is less than 12 hours, 6 hours, or 1 hour. In some embodiments, the method further comprises presenting, by the computer, an interface allowing the employer to immediately schedule a web-based audio and video interview with a matched individual.

In another aspect, disclosed herein are temporary staffing platforms comprising: a processor configured to provide an individual application comprising: a software module configured to provide an interface allowing an individual to create an individual staff profile, the individual staff profile comprising work experience, picture, video, qualifications, and billing rate; a software module configured to provide an interface allowing the individual to indicate availability for temporary staffing assignments, the availability comprising available dates, and for each date, available times; a software module configured to provide an interface allowing the individual to rate employers who have previously hired them for a temporary staffing assignment, the rating added to the employer profile; a software module configured to provide a notification to the individual when they have been selected for a temporary staffing assignment, the notification comprising a response deadline; a processor configured to provide an employer application comprising: a software module configured to provide an interface allowing an employer to create an employer profile, the employer profile comprising one or more descriptions of temporary staffing assignments; a software module configured to provide an interface allowing the employer to rate individuals who have previously performed temporary staffing assignments, the rating added to the individual staff profile; a software module configured to provide an interface allowing the employer to perform a targeted search for individuals suitable for a current temporary staffing assignment; a software module configured to match one or more individuals to the current temporary staffing assignment based on experience, qualifications, billing rate, availability, ratings of the individual by previous employers, and ratings of previous employers by the individual; a software module configured to provide an interface allowing the employer to immediately book a matched individual, the booking generating a notification to the individual comprising a response deadline.

### BRIEF DESCRIPTION OF THE DRAWINGS

FIG. 1 shows a non-limiting exemplary diagram of a process flow; in this case, a diagram depicting a process for an individual staffer to enroll and participate in the temporary staffing exchange described herein.

FIG. 2 shows a non-limiting example of a user interface for a temporary staffing exchange; in this case, an interface for an individual staffer to create an account and configure an individual staff profile with personal information and job categories.

FIG. 3 shows a non-limiting example of a user interface for a temporary staffing exchange; in this case, an interface for an individual staffer to configure an individual staff profile with experience and qualification information.

FIG. 4 shows a non-limiting example of a user interface for a temporary staffing exchange; in this case, an interface for an individual staffer to configure an individual staff profile with background check information.

FIG. 5 shows a non-limiting exemplary diagram of a process flow; in this case, a diagram depicting a process for an employer to enroll and participate in the temporary staffing exchange described herein.

FIG. 6 shows a non-limiting example of a user interface for a temporary staffing exchange; in this case, an interface for an employer to create an account and configure an employer profile with business and contact information.

FIG. 7 shows a non-limiting example of a user interface for a temporary staffing exchange; in this case, an interface for an employer to conduct a targeted search for an individual suitable for a particular temporary staffing assignment.

FIG. 8 shows a non-limiting example of a user interface for a temporary staffing exchange; in this case, an interface for an employer to review a prioritized list of individuals suitable for a particular temporary staffing assignment.

FIG. 9 shows a non-limiting example of a user interface for a temporary staffing exchange; in this case, an interface for an employer to review the profile of a particular identified individual.

FIG. 10 shows a non-limiting example of a user interface for a temporary staffing exchange; in this case, an interface for an employer to confirm a temporary staffing assignment and configure payment information.

FIG. 11 shows a non-limiting example of a response screen providing an employer with information pertaining to a temporary staffing assignment, which has been assigned to a selected individual staffer.

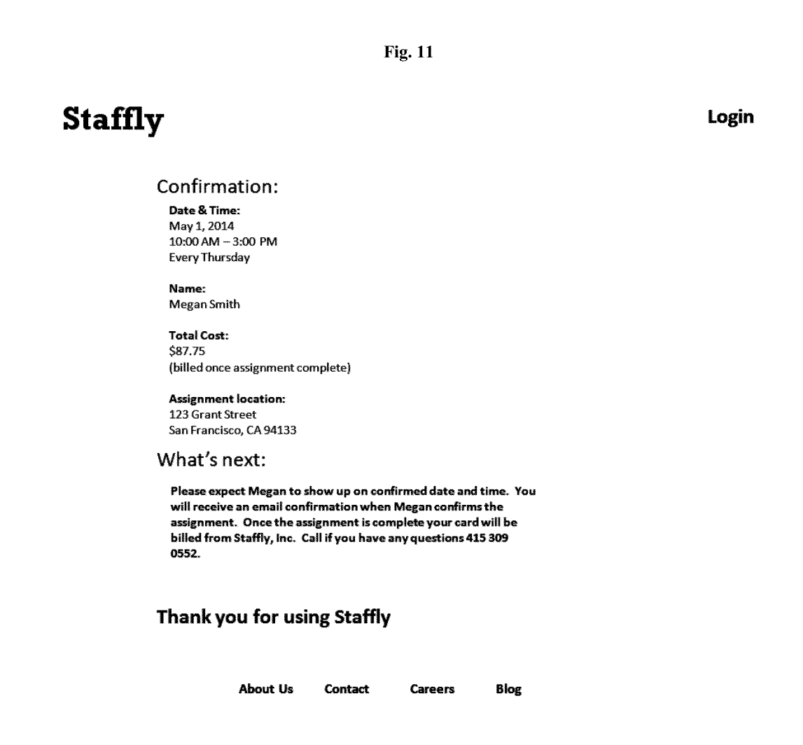

### DETAILED DESCRIPTION OF THE INVENTION

There is a need for an easy-to-use, on-demand market place for temporary staffing services that can efficiently fill these staffing gaps. Employers need pool of available people who meet a known set of qualifications. Individuals who want supplemental or part-time income need a simple place to find part-time work. Existing tools are intended for full-time employment applications and are inadequate to address the unique challenges of temporary staffing.

Temporary staffing needs are rather significant in many different fields. For example, a restaurant may need a replacement waiter on short notice if an employee calls in sick. As another example, a grocery store may need a temporary cashier for a short period of time when one of its cashiers resigns. The number of openings for temporary staffing can be significantly higher than full-time opportunities and sometimes associated with a much more frequent occurrence rate than full-time openings. Further, the need for temporary staffing is much less predictable than full-time employment demands. Due to this unpredictable nature, the number, the duty, or the start time of temporary staffing openings can be constantly changing. In addition, the temporary staffing needs are relatively urgent, i.e., on the scale of less than 1 to 72 hours.

Consequences flow with the aforementioned unique challenges of temporary staffing. First, the searching, matching, or booking of a temporary staff has to be carried out quickly. Thus, there is a need for a temporary staffing platform or system that is efficient and convenient to use during the entire hiring process. Further, such a staffing platform needs to enable a much faster hiring process than a traditional full-time hiring. As a result, there is a demand for direct digital communication between staffs and employers so that a single event of inquiry, messaging, interview, or hiring can be real-time and promptly expedite the hiring process.

Existing tools intended for full-time applications are inadequate as they are not designed to reflect fast-pace changes in the temporary staffing needs. Further, the applying-hiring process is labor and time consuming. An applicant goes through a lengthy process to fill-out details in the application form and is able to contact the employer directly, especially the personnel in charge of the hiring. Further, it is impossible for an employer to book, interview, or hire a qualified applicant immediately via existing job searching websites or tools. Furthermore, ratings, comments, or reviews of an employer or an employee based on one or more previous jobs may not be readily available or relevant for future searching, booking, matching, or hiring events.

Described herein are temporary staffing platforms, systems, and applications to match one or more qualified individuals to one or more temporary staffing openings for an employer. The present invention especially focuses on a pool of staff, employers, and temporary assignments. The present invention allows the hired temporary staff and the hiring employer to enter ratings, reviews, evaluations, or comments for each other based on one or more temporary staffing assignments. Such information provides helpful inputs in the searching, matching, or hiring process for future staffing needs, where temporary staffing assignments recur one or more times. The claimed invention also enables the employer to immediately book a matched individual based optionally on searches and automatic matching events. The present invention also enables directly communication between the employer and the matched staff using a temporary staffing platform, system, or application. For example, real-time notifications, in-application text, audio, or video chat, or in-application interviews are conveniently carried out between an employer and a potential staff within the staffing platform, system, or application. With the currently presented invention, profiling, rating, browsing of profiles, browsing of ratings, targeted searches, matching, booking, and hiring of temporary staffs are conveniently enabled within one temporary staffing platform, system, or application.

Described herein, in certain embodiments, are temporary staffing platforms comprising: a processor configured to provide an individual staff application comprising: a database comprising a plurality of staff profiles, each staff profile associated with an individual and comprising work experience, picture, video, qualifications, billing rate, availability, and ratings by previous employers; a software module configured to provide an interface allowing the individual to rate employers who have previously hired them for temporary staffing assignments; a software module configured to provide a notification to the individual when they have been selected for a temporary staffing assignment; a processor configured to provide an employer application comprising: a database comprising a plurality of employer profiles, each employer profile comprising one or more descriptions of temporary staffing assignments, type of business, url, address, phone number, dress code for assignment, number of employees, owner name, supervisor, and ratings by individual staff previously employed; a software module configured to provide an interface allowing the employer to perform a targeted search for individuals suitable for a current temporary staffing assignment; a software module configured to automatically match one or more individuals to the current temporary staffing assignment based on experience, qualifications, billing rate, availability, ratings of the individual by previous employers, and ratings of previous employers by the individual; a software module configured to provide an interface allowing the employer to immediately book a matched individual, the booking generating a notification to the individual.

Also described herein, in certain embodiments, are computer-implemented systems comprising: a digital processing device comprising an operating system configured to perform executable instructions and a memory; a computer program including instructions executable by the digital processing device to create an individual temporary staffing application comprising: a software module configured to provide an interface allowing an individual to create an individual staff profile, the individual staff profile comprising work experience, picture, video, qualifications, billing rate, and ratings by previous employers; a software module configured to provide an interface allowing the individual to indicate availability for temporary staffing assignments, the availability comprising available dates, and for each date, available times; a software module configured to provide an interface allowing the individual to rate employers who have previously hired them for a temporary staffing assignment; and a software module configured to: provide a notification to the individual when they have been selected for a current temporary staffing assignment; and receive a response to the notification from the individual, the response confirming an immediate booking for the current temporary staffing assignment; provided that the individual is automatically selected for the temporary staffing assignment based on experience, qualifications, billing rate, availability, ratings of the individual by previous employers, and ratings of previous employers by the individual.

Also described herein, in certain embodiments, are non-transitory computer-readable storage media encoded with a computer program including instructions executable by a processor to create a individual temporary staffing application comprising: a software module configured to provide an interface allowing an individual to create an individual staff profile, the individual staff profile comprising work experience, picture, video, qualifications, billing rate, and ratings by previous employers; a software module configured to provide an interface allowing the individual to indicate availability for temporary staffing assignments, the availability comprising available dates, and for each date, available times; a software module configured to provide an interface allowing the individual to rate employers who have previously hired them for a temporary staffing assignment; and a software module configured to: provide a notification to the individual when they have been selected for a current temporary staffing assignment; and receive a response to the notification from the individual, the response confirming an immediate booking for the current temporary staffing assignment; provided that the individual is automatically selected for the temporary staffing assignment based on experience, qualifications, billing rate, availability, ratings of the individual by previous employers, and ratings of previous employers by the individual.

Also described herein, in certain embodiments, are computer-implemented systems comprising: a digital processing device comprising an operating system configured to perform executable instructions and a memory; a computer program including instructions executable by the digital processing device to create an employer temporary staffing application comprising: a software module configured to provide an interface allowing an employer to create an employer profile, the employer profile comprising one or more descriptions of temporary staffing assignments, type of business, url, address, phone number, dress code for assignment, number of employees, owner name, supervisor, and ratings by individual staff previously employed; a software module configured to provide an interface allowing the employer to rate individuals who have previously performed temporary staffing assignments; a software module configured to provide an interface allowing the employer to perform a targeted search for individuals suitable for a current temporary staffing assignment; a software module configured to automatically match one or more individuals to the current temporary staffing assignment based on individual experience, qualifications, billing rate, availability, ratings of the individual by previous employers, and ratings of previous employers by the individual; and a software module configured to provide an interface allowing the employer to immediately book a matched individual, the booking generating a notification to the individual.

Also described herein, in certain embodiments, are non-transitory computer-readable storage media encoded with a computer program including instructions executable by a processor to create an employer temporary staffing application comprising: a software module configured to provide an interface allowing an employer to create an employer profile, the employer profile comprising one or more descriptions of temporary staffing assignments, type of business, url, address, phone number, dress code for assignment, number of employees, owner name, supervisor, and ratings by individual staff previously employed; a software module configured to provide an interface allowing the employer to rate individuals who have previously performed temporary staffing assignments; a software module configured to provide an interface allowing the employer to perform a targeted search for individuals suitable for a current temporary staffing assignment; a software module configured to automatically match one or more individuals to the current temporary staffing assignment based on individual experience, qualifications, billing rate, availability, ratings of the individual by previous employers, and ratings of previous employers by the individual; and a software module configured to provide an interface allowing the employer to immediately book a matched individual, the booking generating a notification to the individual.

Also described herein, in certain embodiments, are computer-implemented methods of booking an individual for a temporary staffing assignment comprising: storing, by a computer, an employer profile comprising ratings by individual staff previously employed for temporary staffing assignments by the employer; storing, by the computer, a plurality of individual staff profiles each comprising ratings of the individual by previous employers; receiving, by the computer, a request by the employer to fill a current temporary staffing assignment; matching, by the computer, one or more individuals to the current temporary staffing assignment based on individual experience, qualifications, billing rate, availability, ratings of the individual by previous employers, and ratings of previous employers by the individual; transmitting, by the computer, a notification to a matched individual when they have been matched to the current temporary staffing assignment; and receiving, by the computer, a response to the notification, the response triggering an immediate booking of the individual for the current temporary staffing assignment.

Also described herein, in certain embodiments, are temporary staffing platforms comprising: a processor configured to provide an individual application comprising: a software module configured to provide an interface allowing an individual to create an individual staff profile, the individual staff profile comprising work experience, picture, video, qualifications, and billing rate; a software module configured to provide an interface allowing the individual to indicate availability for temporary staffing assignments, the availability comprising available dates, and for each date, available times; a software module configured to provide an interface allowing the individual to rate employers who have previously hired them for a temporary staffing assignment, the rating added to the employer profile; a software module configured to provide a notification to the individual when they have been selected for a temporary staffing assignment, the notification comprising a response deadline; a processor configured to provide an employer application comprising: a software module configured to provide an interface allowing an employer to create an employer profile, the employer profile comprising one or more descriptions of temporary staffing assignments; a software module configured to provide an interface allowing the employer to rate individuals who have previously performed temporary staffing assignments, the rating added to the individual staff profile; a software module configured to provide an interface allowing the employer to perform a targeted search for individuals suitable for a current temporary staffing assignment; a software module configured to match one or more individuals to the current temporary staffing assignment based on experience, qualifications, billing rate, availability, ratings of the individual by previous employers, and ratings of previous employers by the individual; a software module configured to provide an interface allowing the employer to immediately book a matched individual, the booking generating a notification to the individual comprising a response deadline.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Overview

In various embodiments, the present invention discloses temporary staffing platforms, systems, or applications to automatically match one or more qualified individuals to one or more temporary staffing openings for an employer. In some embodiments, the claimed invention is not dedicated to matching staff to one or more permanent jobs or long-term jobs, but is specifically focused on temporary and relatively urgent staffing needs of the employer. In some embodiments, the claimed invention allows the employer to perform a targeted search for individuals suitable for a current temporary staffing assignment within the staffing platforms, systems, or applications. In further embodiments, the hired temporary staff and the hiring employer enter ratings for each other based on one or more temporary staffing assignments, which provide helpful searching and matching information for future staffing needs. In further embodiments, based on the results of the targeted searches and the automatic matching events, the employer immediately books a matched individual within the staffing platform, system, or application. In further embodiments, directly communication linkage is built between the employer and the matched staff using the staffing platform, system, or application. For example, real-time notifications, in-application text, audio, or video chat, or in-application interviews are conveniently carried out between an employer and a potential staff within the staffing platform, system, or application. In further embodiments, all of the profiling, ratings, targeted searches, matchings, and booking of a temporary staff are conveniently enabled within a staffing platform, system, or application.

### Assignments

In some embodiments, the assignments are temporary. In some embodiments, an employer hires one or more temporary staff to complete one or more assignments. In further embodiments, the assignment starts in a short period of time after the hiring or the booking of a qualified temporary staff. In other embodiment, the assignment starts immediately after the hiring or booking of a staff. In some embodiments, the assignment is a one-time assignment lasting for any time ranging from 30 minutes up to 12 hours. In some embodiments, the assignment is a repetitive assignment with a time interval between two adjacent repetitions, and with a short period of time between the first and last repetitions. In further embodiments, the short period of time ranges anywhere from 30 minutes to 2 years. In some embodiments, an assignment includes reoccurrences at regular or irregular time intervals. In further embodiments, the reoccurrence is every day, every other day, every weekday, every weekend, once a week, twice a week, three times a week, four times a week, five times a week, six times a week, seven times a week, eight times a week, nine times a week, or ten times a week. In further embodiments, the assignment requires a work time commitment of 30 minutes to 12 hours a day. In yet further embodiments, the assignment requires less than 29 hours of total work hours per week.

In some embodiments, the assignment is not a permanent or a long term job. In some embodiments, the assignment is a temporary replacement for an unexpected absence of a permanent or long term job. In some embodiments, the assignment is a part-time or a short term job. In some embodiments, the assignment needs to be completed locally with the presence of the staff physically at one or more physical locations provided by the employer. In other embodiments, the assignment is completed remotely or does not require the presence of the staff at any locations provided by the employer. In some embodiments, one or more staff are needed to complete a single assignment. In other embodiments, one staff completes multiple assignments of similar or different natures.

In light of the disclosure provided herein, those of skill in the art will recognize that, in some embodiments, temporary assignments are suitable for positions that are characterized by hourly pay, high absenteeism/turn-over, and work that does not require extensive training or start-up time. In some embodiments, the temporary assignment is for work in the service industry, for example, in the restaurant, hospitality, or retail industries. In various embodiments, the temporary assignment is for, by way of non-limiting examples, a cashier, a tutor, a gardener, a landscaper, a plumber, an electrician, a nanny, a coach, a sales representative, an actor, a security guard, a driver, a translator, a shipping clerk, a delivery driver, an usher, a volunteer, a receptionist, a musician, a handyman, a photographer, a therapist, a massage therapist, a construction worker, a body guard, a butler, a realtor, an agent, a pastor, a secretary, a florist, a stylist, a farmer, an administrator, a web designer, a midwife, a fitness trainer, a designer, a teacher, a translator, an IT specialist, a housekeeper, a barber, a cook, a counselor, a consultant, a contractor, a psychic, or the like.

### Staff Profiles

In some embodiments, a staff, i.e., a user of a temporary staffing platform, system, or application, creates and/or edits a staff profile. In some embodiments, a staff profile includes a photo, a self-description, demographical information, an address, contact information, a bio sketch, a resume, a diploma, a degree, a certificate, a license, a work experience, a set of skills, ratings from former and/or current employers, ratings from previous and/or current coworker or collaborators, reviews from pervious and/or current employers, reviews from previous and/or current coworker or collaborators, available times, preference of work hours, staffing objectives, temporary job objectives, preference in staffing locations, transportation means, former employers, former staff coworkers or collaborators, criminal records, background clearance, immunization record, accepted payment, insurance information, health information, area of expertise, age, gender, work availability on weekday, weekend, evening, and night, drug test results, billing rate, qualifications.

In some embodiments, the staff profile shows latest login time of the staff. In other embodiments, the staff profile indicates if the staff is currently offline or logged in. In some embodiments, the staff profile includes a work calendar of the staff showing previous or current work hours and work types. In some embodiments, the staff profile shows previous collaborations with other staff.

In some embodiments, the staff profile shows the number of total or average matches that the staff has been involved in. In some embodiments, the staff profiles show the number of total or average searches that the staff has appeared in. In some embodiments, the staff profile shows the total or average number of notifications that the staff has received per day, per week, per month, or per year. In some embodiments, the staff profile shows the total number of notifications that hasn't been read or replied. In some embodiments, the staff profile also indicates the overall or average response ratio calculated by the total or average number of responses to notifications divided by the total or average number of notifications. Similarly, in various embodiments, the staff profile indicates the overall or average matching ratio calculated by the total or average number of matchings divided by the total or average number of notifications or searches.

In some embodiments, the staff profile includes data analytics of former employers of the staff, previous assignments, total and average assignments or employers in a period of time, total and average pay rate. In some embodiments, the staff profile includes public and private information. In further embodiments, the staff adds and edits information that can be public or private in the profile.

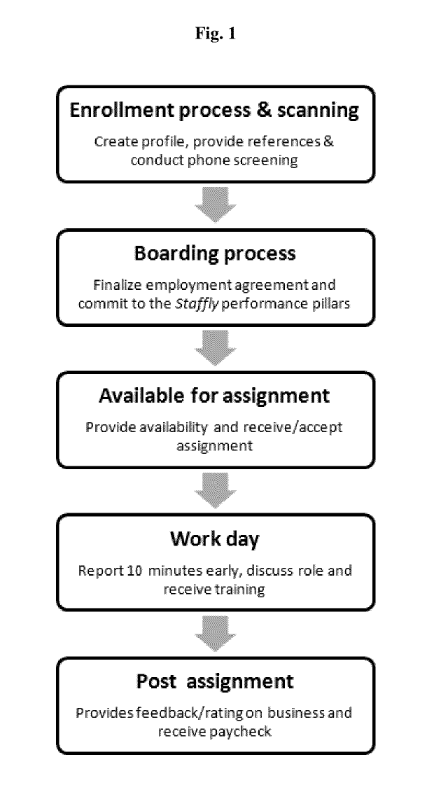

Referring to FIG. 1, in a particular embodiment, a user of a temporary staffing application goes through a process to enroll and participate in the temporary staffing exchange using the staffing application, Staffly. In this embodiment, a staff user creates the staff profile. References and Referee's names are provided optionally. In this embodiment, phone screening is optionally carried out by Staffly members. In the same embodiment, after initial setup and screening, the staff information is entered into the staff database. After a successful booking happens, the staff user finalizes employment agreement with the employer and commits to the Staffly performance pillars. In this embodiment, the staff user provides his or her availability to the employer and updates his or her work hours into his or her staff profile. When a work day starts, the staff user discusses his or her role with the employer and receives necessary training. After the assignment has been completed, the staff user receives his or her paycheck, and both the staff and the employer provide rating and/or review for each other.

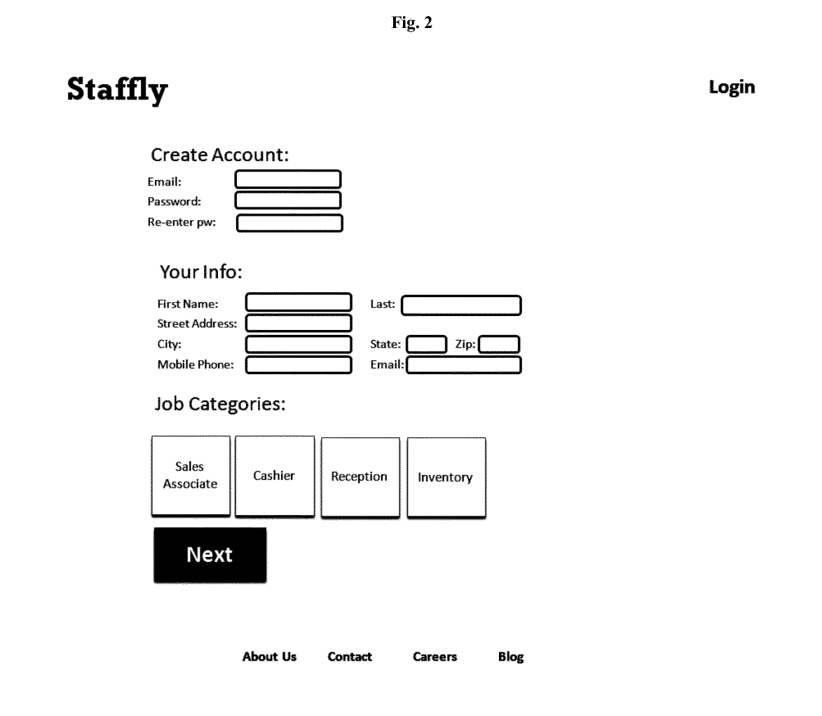

Referring to FIG. 2, in a particular embodiment, a potential staff user creates a staff account. In this embodiment, the potential user enters name, address, phone number, email, and other personal information. In the same embodiment, the potential user also input one or more job categories as his or her job preference.

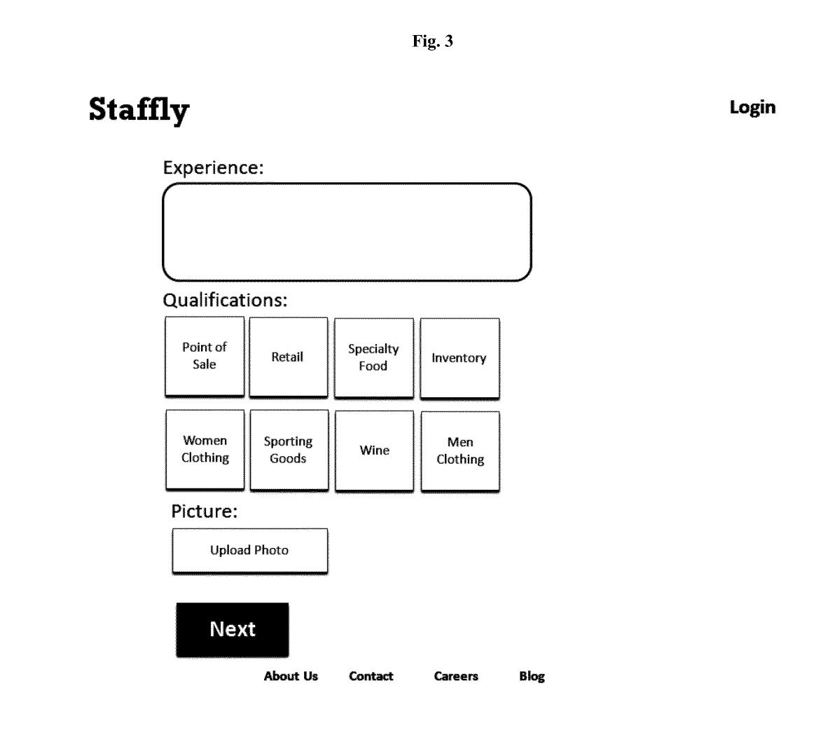

Referring to FIG. 3, in a particular embodiment, a potential staff user creates a staff account. In this embodiment, the potential user enters a description of his or her work experiences. In the same embodiments, the user is provided with an interface to select qualifications in different areas including retail, inventory, women's clothing, wine, men's clothing, point of sale, specialty food. Also in this embodiment, the user has the option to upload a photo.

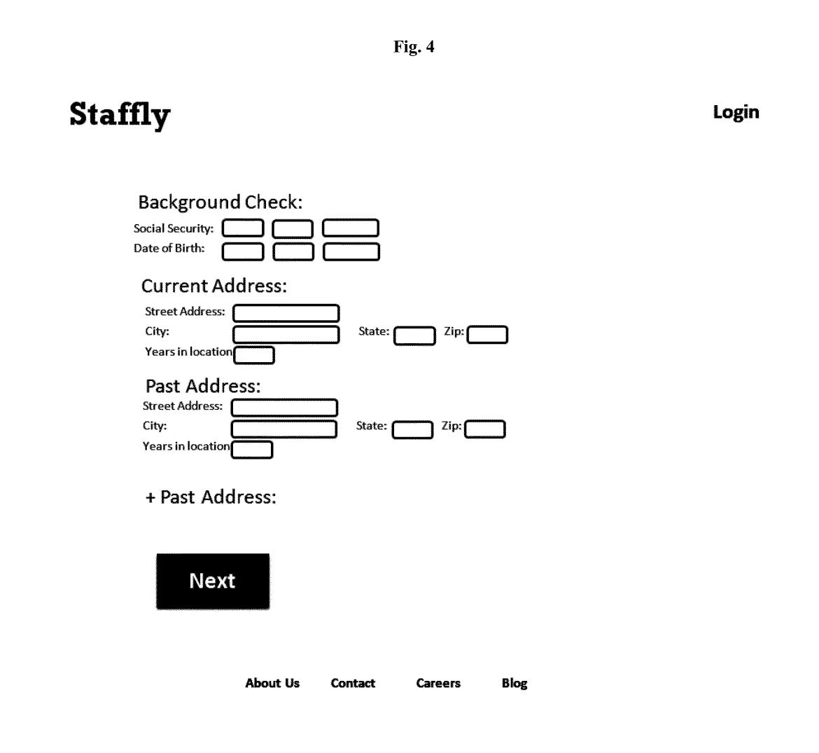

Referring to FIG. 4, in a particular embodiment, a potential staff user creates a staff account. In this embodiment, the potential user enters his or her social security number and date of birth for the purpose of background check. In the same embodiment, additional personal information such current address and past addresses are also entered by the user to allow a thorough and complete background check of the staff user.

### Employer Profiles

In some embodiments, a user of a temporary staffing platform creates and/or edits an employer profile. In some embodiments, the employer is a small business retailer. In some embodiments, an employer profile includes a name of business, a type of business, websites, social network links, URL, a name card, a phone number, a number of employees, an owner name, a supervisor, a manager, one or more addresses of the employer, hours of operation, ratings by former or current temporary staff, reviews by former or current temporary staff, and/or general requirements for temporary staff. In further embodiments, an employer profile includes one or more descriptions of temporary staffing assignments such as dress code for each assignment, one or more addresses for each assignment, and other requirements for each assignment including an education, a license, a safety deposit, a language, an insurance, a criminal record, a background check, a drug test, height, weight, age, gender, ability to lift or carry weight, transportation means, a visa, vaccine, work hour flexibility, on-call availabilities, minimal work hours per day, per week, per month. In some embodiment, the employer profile includes the process flow of searching, matching, booking, hiring, and/or training a new temporary staff. In some embodiments, the employer profile includes payment information, payment method, contact person, and/or contact information.

In some embodiments, an employer profile includes data analytics of public and private information. In some embodiments, an employer profile includes data analytics of former and current temporary staff. In further embodiments, this information include average and total expenses on temporary staff, average and total number of temporary staff, statistics of temporary staff associated information. In further embodiments, this information of an employer's profile facilitates the hiring or management of current and future temporary staff. In some embodiments, the employer's profile includes predictive information of temporary staffing needs in the coming week, in next two weeks, in next three weeks, in next four weeks, in the next month, or in any time ranging from 1 month to 6 months in the future. In further embodiments, the predictive information is generated base on previous staffing information of the employer.

In some embodiments, the employer profile shows the number of total or average matchings that the employer has participated in. In some embodiments, the employer profiles show the number of total or average searches that the employer has performed for one or more staffing assignments. In some embodiments, the employer profile also indicates the overall or average notification ratio calculated by the total or average number of notifications divided by the total or average number of staff in the result of one or more targeted search. Similarly, in various embodiments, the employer profile indicates the overall or average matching ratio calculated by the total or average number of matchings divided by the total or average number of notifications or searches.

In some embodiments, an employer profile includes adding or editing temporary staffing openings and description of details of openings. In other embodiments, the employer profile includes interview announcements. In other embodiments, the employer profile includes the requirement for response after hiring or booking or matching an individual for an assignment.

In some embodiments, an employer profile includes saving or adding staffer's information. In further embodiments, an employer saves a former staff's information into the employer profile for future staff search or matching. In further embodiments, the staff's information includes the staff profile, a link to the staff profile, the staff's previous assignment types, the staff's ID in the staffing application, the staff's salary information, or the like.

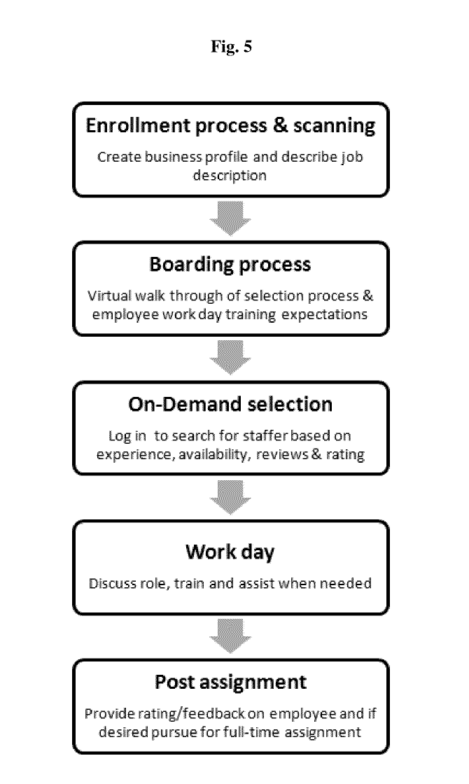

Referring to FIG. 5, in a particular embodiment, an employer user goes through a process to enroll and participate in the temporary staffing exchange. In this embodiment, an employer user creates a business profile using a staffing application, Staffly. The employer also provides a job description for each temporary staffing opening. In the same embodiment, after the initial enrollment and profile set-up, the employer goes through a virtual tour of a targeted staff selection process. The employer also optionally goes through employee work day training expectations. After the employer completes the enrollment and boarding processes, he or she logs in to search for staffers based on staff experiences, availability, ratings, and/or reviews. In the same embodiment, the employer hires one staff based on the automatic matching using Staffly, a temporary staffing application. In this embodiment, when a work day starts, the employer discusses roles with individual new staff, and provides necessary assistance to the new staff. After the assignment has been completed, the staff users receive the paycheck from the employer, and both the staff and the employer provide rating for each other on Staffly. In the same embodiment, the employer optionally selects the staff and extends him or her a full time offer.

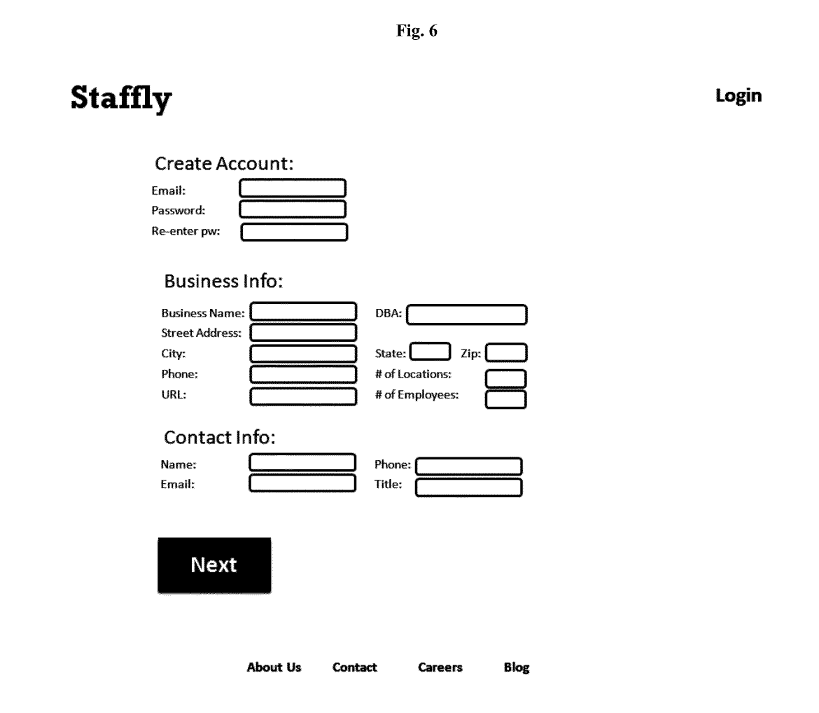

Referring to FIG. 6, in a particular embodiment, an employer user creates an account with Staffly, the temporary staffing application. In this embodiment, the employer enters a business name, a DBA, an acronym for “doing business as”, an address, a phone number, an email, a url, a number of locations, a number of employees. In the same embodiment, the employer also input the contact person's information, which optionally includes a name, a title, a phone number, and an email address.

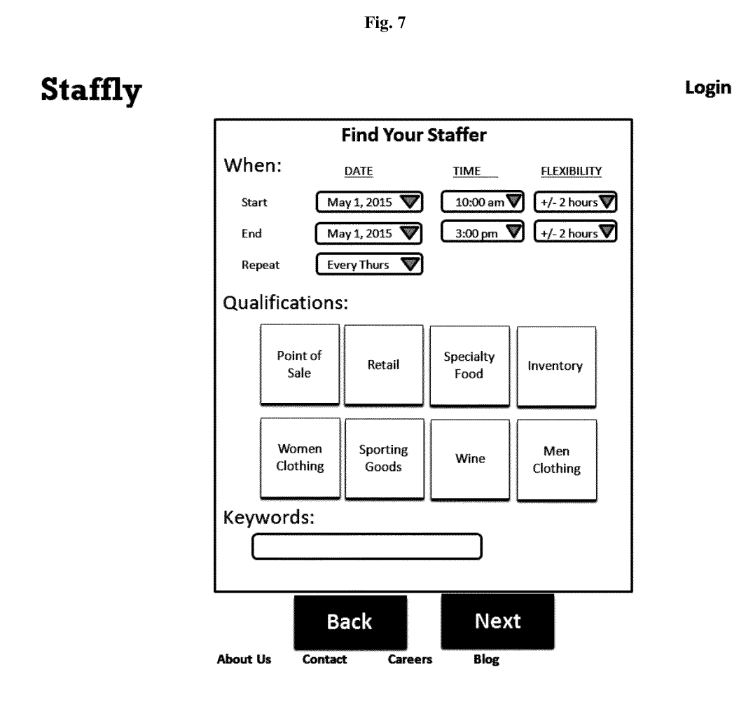

Referring to FIG. 7, in a particular embodiment, an employer conducts a targeted search for temporary staff with the interface provided by Staffly. In this embodiment, the employer enters the start date and end date, and the start time and end time for one temporary assignment. The employer optionally enters the flexibility to be within two hours of the expected start and end time. In the same embodiment, the employer chooses a reoccurrence rate of the assignment to be every Thursday for each week. In the same embodiments, the employer selects qualifications in different areas including retail, inventory, women's clothing, wine, men's clothing, point of sale, specialty food. Also in this embodiment, the employer enters keywords for the targeted search in addition to the selected qualifications.

### Ratings

In some embodiments, the platforms, systems, media, and methods described herein include a ratings, or use of the same. In further embodiments, the platforms, systems, media, and methods described herein include a software module configured to allow an employer to rate one or more temper staff, or use of the same. In other embodiments, the platforms, systems, media, and methods described herein include a software module configured to allow a staff to rate one or more employers, or use of the same. In some embodiments, ratings are included in a staff profile and/or an employer profile. In some embodiments, an employer enters a rating for a former staff based on individual performance on a temporary job or based on general performance on more than one temporary job. In other embodiments, a staff rates one or more other coworker staff or collaborating staff based on previous or existing working experiences. In some embodiments, a staff rates one or more former or current employers. In other embodiments, the staff performs more than one assignments for a single employer, the rating is included as part of each individual assignment of the staff. In some embodiments, the rating is based on overall performances in one or more individual assignments, services, or jobs, wherein the assignments, services or jobs are of different or similar responsibilities. In other embodiments, the rating is based on accumulative or comprehensive performance over a certain period of time, such as a week, two weeks, three weeks, a month, two months, three months, four months, five months, six months, seven months, eight months, nine months, ten months, eleven months, or a year.

In some embodiments, a rating reflects a staff's performance in one or more assignments. In further embodiments, a rating is giving regarding one or more aspects related to temporary staffing. In further embodiments, these rating aspects includes one or more selected from the list of ability to respond to a hiring or a booking within the required time frame, ability to show up on time, quality of work, work ethics, problem solving skills, technical qualification, technical performance, ethical performance, ability to finish work on time, ability to show up on time, communication skills, presentation skills, interpersonal skills, writing skills, problem solving skills, emergence handling skills, ability to follow instructions, ability to collaborate, organization skills, comprehension of instruction, attitude toward the work, personal hygiene, attendance, teamwork, time management skills, personality, and/or attention to details. In other embodiments, a rating includes one or more aspects selected from the list of ability to honor a hiring or a booking, ability to provide training, quality of training, ability to provide instruction, effectiveness of instruction, ability to communicate to a staffer, ability to maintain a friendly work environment, ability to maintain a clean and neat work environment, ability to provide resources to work-related accidents and injuries, ability to address work-related issues, work distribution, work product examination, and fairness. In some embodiments, the rating includes evaluation of one or more of review aspects.

In some embodiments, the rating also includes a review covering contents related to the employer, staff, or one or more assignments. In some embodiments, a review includes evaluation regarding one or more rating aspects. In further embodiments, a review includes one or more aspects of ability to respond to a hiring or a booking within the required time frame, ability to show up on time, quality of work, work ethics, problem solving skills, technical qualification, technical performance, ethical performance, ability to finish work on time, ability to show up on time, communication skills, presentation skills, interpersonal skills, writing skills, problem solving skills, emergence handling skills, ability to follow instructions, ability to collaborate, organization skills, comprehension of instruction, attitude toward the work, personal hygiene, attendance, teamwork, time management skills, personality, and/or attention to details. In other embodiments, a review includes one or more aspects of ability to honor a hiring or a booking, ability to provide training, quality of training, ability to provide instruction, effectiveness of instruction, ability to communicate to a staffer, ability to maintain a friendly work environment, ability to maintain a clean and neat work environment, ability to provide resources to work-related accidents and injuries, ability to address work-related issues, work distribution, work product examination, and fairness. In some embodiments, one or more aspects of rating and/or review are used as searching criteria or searching keywords.

In some embodiments, a rating includes a reference or a recommendation by another user, i.e., a staff or an employer. In further embodiments, the reference or the recommendation includes a general evaluation or evaluation of one or aspects that can be used in a targeted search, a rating, or a review. In some embodiments, the recommendation or reference includes information regarding one or more assignments, the responsibilities of the staff, the work start and end time, the work hours per day, per week, or per month.

In various embodiments, a software module configured to allow a staff or an employer, i.e., a user, to rate a service, i.e., a temporary assignment, or another user using a wide array of suitable rating methods. In some embodiments, a user rates the service or another user by responding to a survey. In various embodiments, a survey suitably includes about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more questions. In some embodiments, a rating includes comments, feedbacks, descriptions, or recommendations. In various embodiments, the rating is entered anonymously. In other embodiments, the rating is entered with user ID or other identification information of the rating user, such as demographical information and geolocation information.

In some embodiments, a user rates the service or another user by voting to indicate preference or degree of preference. In other embodiments, a user votes to indicate disfavor or degree of disfavor. In further embodiments, a user votes selecting from, by way of non-limiting examples, “Yes” or “No,” “Like” or “Dislike,” and “Up” or “Down.” In other embodiments, a user votes by making a selection from a scale. Many scales are suitable for user voting in response to a prompt for a reaction. In various embodiments, suitable scales include, by way of non-limiting examples, 2-step, 3-step, 4-step, 5-step, 6-step, 7-step, 8-step, 9-step, 10-step, 11-step, 12-step, 13-step, 14-step, 15-step, 16-step, 17-step, 18-step, 19-step, 20-step or more scales. In further embodiments, a user votes by selecting from a scale such as, from 1 to 3, from 1 to 5, from 1 to 10, from 1 to 100, from A to C, from A to D, from A to F, and the like. In a particular embodiment, a user votes by selecting from a Likert Scale, including selections such as “Strongly disagree,” “Disagree,” “Neither agree nor disagree,” “Agree,” and “Strongly agree.”

In some embodiments, a user rates the service or another user by ranking elements. In further embodiments, a user ranks to indicate preference or degree of preference. In other embodiments, a user ranks to indicate disfavor or degree of disfavor. In some embodiments, a user ranks by assigning one or more numbers (e.g., 1, 2, 3, etc.). In other embodiments, a user ranks by assigning one or more letters (e.g., A, B, C, etc.). In other embodiments, a user ranks by assigning one or more stars (e.g., 1 star, 1.5 stars, 2 stars, 2.5 stars, 3 stars, 3.5 stars, 4 stars, 4.5 stars, 5 stars, etc).

In various embodiments, a user reviews the service, i.e., the temporary staffing assignment or another user, i.e., an employer or another staff by entering comments. In some embodiments, the comments are made in regard to a service or a user in general. In other embodiments, the comments are made to a rating or a review aspect. For example, a user specifically reviews an employer's ability to provide training. In certain embodiments, the comments are made in forms of answers to one or more questions. In some embodiments, the comments are made in addition to a rating.

In some embodiments, the rating and/or review information and/or the number of ratings and/or reviews is used in a targeted search to rank search results. In further embodiments, the user with better rating or review ranks higher in a search result list than a user with a lower rating and/or review. In other embodiments, the user with more individual rating and/or review entries appears higher in a search result list than a user with less rating and/or review entries.

In some embodiments, the rating and review information are used to filter and preselect staff in a database. In further embodiments, the filtering and preselection uses one or more filtering criteria including work location, payment methods, membership type, membership start date, experiences, pay rate, employer type, employer name, job category, area or expertise, assignment types, assignment duration, date, month, year, and/or criteria used in a targeted search or a matching event.

In some embodiments, the rating information includes a numerical score. In further embodiments, the rating score is calculated automatically based on the rating information entered by a staff user or an employer user. In further embodiments, the rating score is obtained from a statistical, numerical, mathematical, empirical, or modeling algorithm.

### Notifications

In some embodiments, a notification is sent to the individual user when the user has been searched, matched, booked, or hired for a temporary staffing assignment. In further embodiments, the employer or an agent of the employer sends the notification to the individual user when the user has been searched, matched, booked, or hired for a temporary staffing assignment. In other embodiments, the notification is sent automatically via the staffing platform, system or application. In further embodiments, the notification is send real-time. In some embodiments, the notification includes one or more selected from the list of an assignment name, an assignment type, an assignment location, dates and times of work, work hours, an hourly pay, start time of the assignment, end time of the assignment, a request for a reply from the staff, a time window for a reply form the staff, required information in a reply to the notification, the employer's profile, a link to employer's website, a link to employer's profile, a link to employer's social network pages, a phone number of employer, contact person's information, or other related information.

In some embodiments, a notification is send with a requirement to respond within a designated time frame. In further embodiments, the time frame is determined automatically by the platform or by the employer to be anywhere from 30 minutes to 24 hours. In further embodiments, the notification can be retrieved or become ineffective if no response is received within the selected time frame. In further embodiments, the employer will move on to book another matched individual for the assignment. In other embodiments, the response can be a reply to the notification. In further embodiments, the reply is sent via a text message, a voice message, a video message, an email, a phone call, a conference call, an text message within the staffing application, a voice message within the staffing application, a video message within the staffing application, a message using third-party application or software, a fax, a mail, or similar communication means.

In some embodiment, a notification is sent to a staff if an employer views the staff's profile. In further embodiment, the notification contains one or more selected from the list of the employer's name, the date and time of each viewing, a number of total viewings, the employer's profile, a link to the employer's website, a link to the employer's social network pages, or a link to the employer's profile. In other embodiments, a notification is sent to a staff if the staff appears to be top 1, top 3, or top 5 of a result list from a targeted search. In some embodiments, a notification is sent to a staff when the staff has been searched by one or more specific employers. In further embodiments, the notification includes information regarding details of each targeted search, date and time of each search, the employer who performed each search, a link to the employer's profile, the employer's profile, a link to employer's website or social networking pages. In some embodiments, a notification is sent to a staff when an employer requests an interview. In further embodiments, the notification includes an assignment name, an assignment type, an assignment location, dates and times of work, work hours, a link to employer's website, a link to employer's profile, a link to employer's social network pages, a phone number of employer, contact person's information, an hourly pay, date and time of the interview, a proposed duration of the interview, a location of the interview, interviewer's name, and/or interviewer's contact information.

In some embodiments, a notification is sent to a hired staff before the start time of an assignment. In further embodiments, the notification is sent 1 hour, 2 hours, 3 hours, 4 hours, 5 hours, 6 hours, 7 hours, 8 hours, 12 hours, 16 hours, 18 hours, or 24 hours before the start time of the assignment. In some embodiments, the notification includes details of assignment name, location, work times, work hours, link to employer's website, phone number of employer, contact person's information, hourly pay. In some embodiments, a notification contains information about a request to respond within a designated time period. In other embodiment, the notification includes a link to a URL that contains details of assignment including assignment name, location, work times, work hours, link to employer's website, phone number of employer, contact person's information, hourly pay. In some embodiments, the notification contains a link for the staff to respond. In further embodiments, the staff is directed to an in-application communication means of a staffing application via the link. In some embodiments, the notification includes information regarding preparations for the first day of the assignment. In further embodiments, the preparations include a dress code, a social security card, a passport, a copy of the signed offer, a driver's license, an insurance card, a uniform, or other necessary preparations.

In some embodiments, a notification is sent to an employer when a staff responds to a previous notification sent by the employer. In some embodiments, a notification is sent to an employer when a staff signs an offer, an agreement, a contract, a deal, a signature, or other legally related documents that is related to the employer. In some embodiments, a notification is sent to an employer when a staff is booked or matched to one or more assignments. In some embodiments, the notification includes an assignment name, an assignment location, dates and times of work, work hours, hourly rate, a staff name, a staff profile, a link to the staff profile, a staff's reply to a previous notification, or other related information.

In some embodiments, a notification is an automatically sent by the staffing application, system, or method. In other embodiments, the notification is sent by an employer, a staffer, an agent, or third-party personnel. In some embodiments, a notification is sent from a user to one or more users of a staffing application. In some embodiments, a notification is a digital communication between two users, or among multiple users of a staffing application, system and application. In some embodiments, the notification is sent via a text message, a voice message, a video message, an email, a phone call, a conference call, a text message within the staffing application, a voice message within the staffing application, a video message within the staffing application, a message using third-party application or software, a fax, a mail, or similar communication means. In some embodiments, the notification is a text message, a voice message, a video message, an email, a phone call, a conference call, a text message within the staffing application, a voice message within the staffing application, a video message within the staffing application, a message using third-party application or software, a fax, a mail, or similar communication means.

### Targeted Searches

In some embodiments, a temporary staffing platform, system, or method provides an interface allowing the employer to perform a targeted search for individuals suitable for a current temporary staffing assignment.

In some embodiments, the targeted search is performed within the staffing platform, system, or application initiated by an employer. In some embodiments, the targeted search is performed with the platform, system, or application initiated by a potential staff. In some embodiments, the targeted search is set up by the employer or the potential staff to be repetitive on a regular or irregular time basis. In further embodiments, the employer selects one or more search criteria in a targeted search. In some embodiments, the search criteria include one or more of assignment openings, time of assignment openings, hourly pay, availability, a qualification, a job category, a keyword, a rating, and a review. In some embodiments, one or more aspects of a rating or a review are used in the search criteria. In further embodiments, an overall rating score or a rating score of one or more rating aspects is used in the search criterion. For example, a rating score of 3 stars out of 5 stars in the rating aspect of “time management skills” is used as a search criterion. In other embodiments, search criteria include one or more of job category, technical qualification, hourly rate, years of experience, address, vicinity to work, photo, licenses, transportation means, ratings, reviews, citizenship, availability, language, insurance, criminal record, background check, education, drug test, height, weight, age, gender, ability to lift or carry weight, transportation means, language, visa, vaccine, work hour flexibility, on-call availability, minimal work hours per day, per week, per month, earliest availability, previous temporary staffing experience, former temporary staffing coworker or collaborator, former temporary staffing employer, ability to respond to a hiring or a booking within the required time frame, ability to show up on time, ability to manage time during the assignment, quality of work, work ethics, problem solving skills, technical qualification, technical performance, ethical performance, ability to finish work on time, ability to show up on time, communication skills, presentation skill, interpersonal skills, problem solving skills, ability to follow instructions, ability to collaborate with others, time management skills, personality, and/or attention to details. In other embodiments, search criteria include one or more aspects of ability to honor a hiring or a booking, ability to provide training, quality of training, ability to provide instruction, effectiveness of instruction, ability to communicate to a staffer, ability to maintain a friendly work environment, ability to maintain a clean and neat work environment, ability to provide resources to work-related accidents and injuries, ability to address work-related issues, work distribution, work product examination, and fairness.

In some embodiments, job categories include one or more of retail, inventory, warehouse, sales, customer service, shipping, labor, repair, installation, restaurant, transportation, education, construction, information technology, hotel, accounting, clothing, specialty food, marketing, social services, finance, accounting, wine, automotive, training, engineering, volunteer, real estate, insurance, tax, skilled labor, supply chain, writing, translation, clerical, security, manufacturing, cleaning, mortgage, human resources, librarian, catering, agriculture, law, mathematics, sports, veterinary, music, science, zoology, internet, or the like.

In some embodiments, the search criteria are treated equivalently in a targeted search. In other embodiments, the search criteria are ranked by their importance. In other embodiments, the search criteria are given different weighting. The most important search criteria are given the highest weighting and the criteria that are equally important are given similar weighting. The weighting value can be customized by the employer to reflect the importance of each criterion in the targeted search. For example, when an employer needs a staff that is very close to a work location or a staff has a really good rating, the employer selects “the distance to work” and “rating” with a high weighting, i.e., 20, while the rest of the criteria with a low weighting, i.e., 1. In other embodiments, the targeted search schemes are adapted from existing statistical, mathematical, computational, optimization, or modeling algorithms. In some embodiments, the targeted search uses a third party search engine such as google, yahoo, Bing, baidu, etc.

In some embodiments, the targeted search is performed using filtering. The aspects of a filtering criterion are the same as the aspects of a search criterion. For example, the employer can select a filter in the “hourly rate” requirement and filter out all the staff with an hourly rate higher than 15 dollars.

In various embodiments, the targeted search is performed using predictive keywords. In some embodiment, a keyword is used in combination with one or more search criteria in a targeted search. In some embodiments, a keyword provides specific information regarding a searching criterion. In other embodiments, a keyward provides information in addition to a search criterion. For example, a keyword “food allergy” provides additional information to a search criterion of “food service.” In further embodiments, one or more search keywords are related to one or more of a search criterion, a rating aspect, and a review aspect. For example, a keyword “Spanish” is related to the search criterion “language”. In various embodiments, keywords are selected in one or more fields of job category, qualification, language, visa, hourly rate, skills, distance to location, years of experiences, number of ratings, rating information, job category, technical qualification, hourly rate, years of experience, address, vicinity to work, photo, licenses, transportation means, ratings, reviews, citizenship, availability, language, insurance, criminal record, background check, education, drug test, height, weight, age, gender, ability to lift or carry weight, transportation means, language, visa, vaccine, work hour flexibility, on-call availability, minimal work hours per day, per week, per month, earliest availability, previous temporary staffing experience, former temporary staffing coworker or collaborator, former temporary staffing employer, ability to respond to a hiring or a booking within the required time frame, ability to show up on time, ability to manage time during the assignment, quality of work, work ethics, problem solving skills, technical qualification, technical performance, ethical performance, ability to finish work on time, ability to show up on time, communication skills, presentation skill, interpersonal skills, problem solving skills, ability to follow instructions, ability to collaborate with others, time management skills, personality, attention to details, or other fields that are commonly used in a searching criterion. In further embodiments, the keywords are combined in a targeted search using logical operators or connectives. For example, a targeted search can search keyword “Spanish” in language in combination with “no less than 1 year” in experience requirement.

In some embodiments, the targeted search is the combination of multiple searches. In further embodiments, the combination of multiple searches can be by any logical operators or logical connectives. In further embodiments, the logical operators or connectives can be used in different search fields or in the same search field. For example, a search requiring “more than 20 ratings” in the fields of “number of ratings” can be combined with “less than 100 ratings” to select staff with a rating number between 20 and 100.

In various embodiments, the targeted search will generate a list of staff based on the search criteria, keywords, or filtering. In further embodiments, the number of staff to appear in a search list is determined by the employer. In some embodiments, the number of staff to appear in a search list is 1, 2, 3, 4, 5, 6, 7, 8, 9, or 10 staff. In further embodiments, the staff that is the closest match to the searching criteria, keywords, or filtering appears at the top of the search list. The search result list contains a link to the matched staff profile. In some embodiments, the search result link contains a link to send a notification. In other embodiments, the search result list includes link to initiate an instant interview if the staff is currently logged in the staffing system. In other embodiments, the employer contacts the staff via an automatically generated message or a customized message. In other embodiments, the employer communicates with a matched staff via text message, email, phone call, fax, social network, or other means.

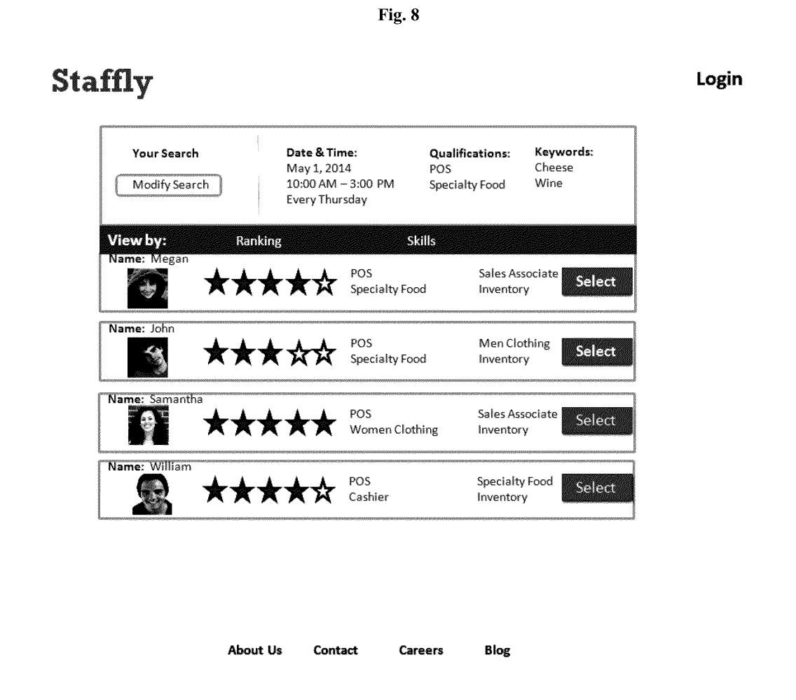

Referring to FIG. 8, in a particular embodiment, the employer is provided an interface by the staffing application, Staffly, to view a prioritized list of results of individuals suitable from a targeted search. The search criteria are displayed via the interface to the employer, which includes work date and time, qualifications, and keywords. In this embodiment, the employer searched the Staffly database optionally using qualifications including point of sale and specialty food along with keywords of “cheese” and “wine”. In the same embodiments, four individual staffers are shown and ranked by their qualifications, skills, and rankings. The employer optionally modifies the search criteria if none of the four individuals are satisfactory due to various reasons.

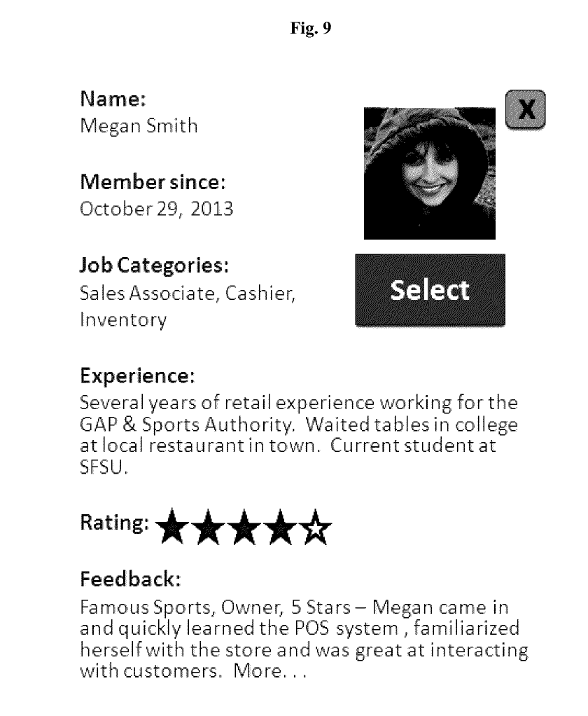

Referring to FIG. 9, in a particular embodiment, the employer is directly linked to view a staff profile by the staffing application, Staffly. In this embodiment, the employer is linked to the staff profile from a prioritized list of results with individuals suitable for a targeted search. In this embodiment, the employer views the profile of a staff member. In the same embodiments, the staff profile includes a name, a membership start time, job categories, work experiences, ratings by former employers, and feedback information from a former employer.

### Matching

In some embodiments, one or more qualified staff are matched to an employer for one or more current temporary staffing assignments. In some embodiments, the matching is automatically performed by the staffing platform, system, or application. In some embodiments, the matching of a staff to a temporary staffing assignment is based on the same criteria used in a targeted search. In some embodiments, the match criteria include one or more of a search criterion, a search keyword, a rating aspect, and a review aspect. In further embodiments, the matching criteria include one or more selected from the list of a job category, a qualification, a keyword, a rating, a review, an availability, a hourly rate, years of experience, vicinity to work, licenses, transportation means, ratings, availability, language, insurance, criminal record, background check, drug test, height, weight, age, gender, photo, ability to lift or carry weight, transportation means, language, visa, vaccine, work hour flexibility, on-call availabilities, minimal work hours per day, per week, per month, earliest availability, previous temporary staffing experience, former temporary staffing coworker or collaborator, former temporary staffing employer, ability to respond to a hiring or a booking within the required time frame, ability to show up on time, ability to manage time during the assignment, quality of work, work ethics, problem solving skills, technical qualification, technical performance, ethical performance, ability to finish work on time, ability to show up on time, communication skills, presentation skill, interpersonal skills, problem solving skills, ability to follow instructions, ability to collaborate with others, time management skills, personality, and attention to details. In other embodiments, matching criteria include one or more aspects of ability to honor a hiring or a booking, ability to provide training, quality of training, ability to provide instruction, effectiveness of instruction, ability to communicate to a staffer, ability to maintain a friendly work environment, ability to maintain a clean and neat work environment, ability to provide resources to work-related accidents and injuries, ability to address work-related issues, work distribution, work product examination, and fairness.

In some embodiments, a matching is obtained from the search results from one or more targeted searches. In some embodiments, a matching is obtained from the results of filtering. In other embodiments, a matching is obtained from one or more databases of staff. In some embodiments, the matching is obtained from previously hired temporary staff. In some embodiments, the matching is obtained from staff that have been saved by one or more employers. In some embodiments, the matching is obtained from recommended staff by another staff or employer. In other embodiments, a matching is obtained from a referral or a recommendation. In certain embodiments, the matching is obtained from staff that have expressed interests in the assignment. In some embodiments, the matching is obtained from staff that have communicated with the employer either physically or electronically. In some embodiments, the matching is initiated automatically. In other embodiments, the matching is initiated by the employer. In some embodiments, the matching is a one-time event. In other embodiments, the matching occurs more than once with arbitrary time intervals in between two matchings and with an arbitrary number of repetitions. In some embodiments, the matching algorithm remains unaltered when it is repeated. In other embodiments, the matching algorithm changes when it is repeated. In some embodiments, the matching algorithm can be preselected automatically by the platform, system, or application. In other embodiments, the matching algorithm is determined by the employer.

In some embodiments, the matching criteria are treated equivalently in a matching event. In other embodiments, the matching criteria are ranked by their importance. In other embodiments, the matching criteria are given different weight. The most important matching criteria are given the highest weight and the matching criteria that are equally important are given similar weight. The weight value can be customized by the employer to reflect the importance of each criterion in the matching. For example, if an employer needs a staff really close to a work location and starts immediately, he or she can select “location” and “earliest availability” with a weighting of a 100, while the rest of the criteria with a weighting less than 10. In other embodiments, the matching schemes are adapted from existing statistically, mathematical, computational, or modeling algorithms. In some embodiments, the matching uses a third party algorithm.

In some embodiments, one or more matches can be found using the matching algorithm. For example, a system finds 3 staff that are within 2 miles of a work location and all of them can start working within an hour. In some embodiments, the matches are further ranked based on one or more secondary criteria selected from the searching and matching criteria, such as rating or experiences. In other embodiments, matches are presented to the employer with a random order.

In other embodiments, no exact match can be found using the matching algorithm. In further embodiments, an employer can select to see a list of staff that are not exactly matched but close to the match criteria. In other embodiments, an employer can change matching or searching criteria to conduct one or more additional search or matching events. In other embodiments, an employer can keep the matching criteria but require a matching event at a later time point or at multiple time points later until at least one exact match has been found.

### Booking

In some embodiments, the employer immediately book one matched individual from the matching event. In some embodiments, the employer initiates an online or offline interview after or before the booking. In further embodiments, the interview and/or booking is completed within a staffing application. In some embodiments, the booking involves an offer, an agreement, a contract, a deal, a signature, or other legally related documents. In some embodiments, the booking is conditional. In further embodiments, the booking becomes unconditional when the booked individual replies with a response. In further embodiments, the response includes a signed offer, a signed agreement, a signed contract, a signed deed, or other signed legal documents. In some embodiments, the signature on documents is physical. In other embodiments, the signature is electronic signature. In other embodiments, the response includes an effective reply via electronic or physical communication means. In some embodiments, booking with an effective reply indicates a successful hiring. In further embodiments, the successful hiring is reflected on the staff and/or employer profile.

In some embodiments, when the booking is unsuccessful due to no response from the staff. The employer goes back to the targeted search, matching in order to start another booking. In other embodiments, when the booking is unsuccessful due to other reasons in the booking process caused by the employer and/or the staff, a rating or a review is generated automatically by the application, platform or system to the employer and/or staff.

In some embodiments, a part of payment is due upon successfully hiring from the employer. In other embodiments, the payment is due from the employer before the rating is entered for the specific employer. In other embodiments, the payment is due after the assignment has been finished. In some embodiments, the payment is due in part after each repetition if a single assignment contains more than one repetition. In some embodiments, the payment is paid directly to the staff from the employer. In other embodiments, the payment is recorded by the staffing application, platform, or system after the successful hiring. In certain embodiments, the payment is from the employer to the staffing application, and then from the staffing application to the staff.

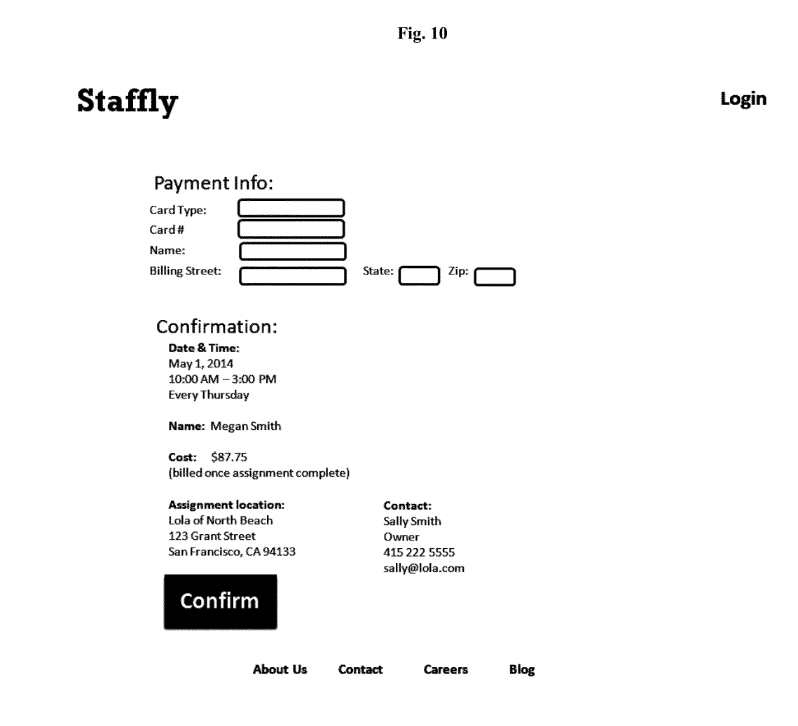

Referring to FIG. 10, in a particular embodiment, an employer configures payment information optionally after a successfully hiring has been confirmed by the staffing application. In this embodiment, the employer enters payment information including card type, number, name, and billing address. In the same embodiment, the assignment confirmation is shown with the date time, and location of the assignment. Also in this embodiment, the total amount of payment for the assignment is optionally presented to the employer. The payment is due from the employer upon completion of the assignment. Also in this embodiment, the information of the contact person of the employer is also included.

Referring to FIG. 10, in a particular embodiment, a response screen is optionally provided to the employer after a successfully payment configuration has been confirmed in the staffing application. In this embodiment, the assignment confirmation is presented to the employer with the date, time, and location of the assignment, the name of the hired staff, and the total amount of payment for the assignment. The payment is due from the employer upon completion of the assignment. Also in this embodiment, the employer is provided a message regarding the optional steps following the assignment confirmation.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of employer, staff, and temporary staffing assignment information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Individual Process

A yoga professional browses local employer profile for possible temporary openings for a yoga coach using a staffing application. She is notified by the system that her profile has appeared in a targeted search conducted by a local Yoga studio. She opens the system notification, and clicks the link to view the Yoga studio's profile. She specifically looks for the assignment openings posted on the employer's profile and sees one assignment that fits her schedule and expertise. She then sends an email to the owner's email address listed on the profile and expresses her interests in the position. She also sends her resume and references. After seeing her email, the owner of the Yoga studio then requests an in-app video interview with her.

### Example 2

### Employer Process

A local Japanese restaurant needs a temporary waitress or waiter to cover a busy Friday night shift after a waiter called in sick 6 hours before his shift. The restaurant manager logs into Staffly, a mobile staffing application, and starts to search for replacement. The manager uses a search filter to filter out those staff that are currently not logged in to the mobile app. The manager then searches for staffers within the job categories of “restaurant” and “waiter/waitress” along with two further search criteria—“address less than 10 miles” from the restaurant location and “Japanese” in language. More than 5 staff shows up from the search. To further select a qualified match from the list of search results, the manager refines his search and adds his own restaurant name as an additional keyword. One staff appears to have worked in his restaurant. The manager opens this staffer's profile, and sees that the particular staff worked one year ago in his restaurant, and received a rating of 4 stars out of 5 stars. He quickly booked this individual staffer by sending a conditional notification with the assignment information and pay rate information, the conditional notification says this booking becomes ineffective without a response after 30 minutes. In 5 minutes, the manager receives an in-app text message confirmation from the staffer. He sends an offer for the staffer's signature.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. An electronic temporary staffing platform comprising:
a. a processor configured to provide an individual staff application comprising:
i. a database comprising a plurality of staff profiles, each staff profile associated with an individual and comprising a first plurality of scaled ratings on a scale with more than two rating levels by previous employers, and one or more of work experience, picture, video, qualifications, billing rate, and availability;
ii. a software module configured to provide an interface allowing the individual to rate employers who have previously hired them for temporary staffing assignments, wherein the rating is scaled, and wherein the scale comprises more than two rating levels;
iii. a software module configured to provide an automatic and real-time notification to the individual when they have been matched and selected for a temporary staffing assignment;
b. a processor configured to provide an employer application comprising:
i. a database comprising a plurality of employer profiles, each employer profile comprising a second plurality of scaled ratings on the scale with more than two rating levels by individual staff previously employed, and one or more descriptions of temporary staffing assignments, type of business, url, address, phone number, dress code for assignment, number of employees, owner name, and supervisor;
ii. a software module configured to provide an interface allowing the employer to perform a targeted search for individuals suitable for a current temporary staffing assignment;
iii. a software module configured to automatically match one or more individuals to the current temporary staffing assignment based on experience, qualifications, billing rate, availability, the first plurality of scaled ratings of the individual by previous employers, and the second plurality of scaled ratings of previous employers by the individual;
iv. a software module configured to provide an interface allowing the employer to immediately book a matched individual within the temporary staffing platform, the booking generating an automatic and real-time notification to the individual within the temporary staffing platform;
v. a software module configured to conduct an audio or video interview with a matched individual within the temporary staffing platform, wherein the audio or video interview is conducted live, directly between the employer and the matched individual.

2. The platform of claim 1, wherein the individual ratings provided by previous employers each comprise a score.

3. The platform of claim 2, wherein a high score provided by a previous employer for an individual increases the probability for a match between the employer and the individual for a current temporary staffing assignment.

4. The platform of claim 1, wherein the employer ratings provided by an individual previously employed each comprise a score.

5. The platform of claim 4, wherein a high score provided by an individual for a previous employer increases the probability for a match between the individual and the employer for a current temporary staffing assignment.

6. The platform of claim 1, wherein the software module configured to automatically match one or more individuals to the current temporary staffing assignment returns a prioritized list of matched individuals.

7. The platform of claim 6, wherein the prioritized list of matched individuals is based on one or more of: availability, billing rate, skills, location of assignment, and rating.

8. The platform of claim 1, wherein the notification comprises a response deadline.

9. The platform of claim 8, wherein if the notification is not responded to prior to the response deadline, a next individual is matched to the current temporary staffing assignment.

10. The platform of claim 8, wherein the response deadline is less than 1 day.

11. The platform of claim 8, wherein the response deadline is less than 12 hours, 6 hours, or 1 hour.

12. The platform of claim 1, wherein the current temporary staffing assignment comprises no more than 29 hours of work per week.

13. The platform of claim 1, wherein the employer application further comprises a software module configured to provide an interface allowing the employer to configure payment for temporary staffing assignments performed.

14. (canceled)

15. The platform of claim 1, wherein the individual staff application further comprises a software module configured to provide an interface allowing the individual to configure receipt of payment for temporary staffing assignments performed.

16. The platform of claim 1, wherein the software module configured to provide an interface allowing the employer to perform a targeted search for individuals provides predictive keyword suggestions.

17. The platform of claim 1, wherein the individual staff application comprises a mobile application.

18. The platform of claim 17, wherein the individual staff application further comprises a software module configured to provide an interface allowing the individual to obtain a supervisor signature at the end of an assignment documenting that the assignment is complete.

19. The platform of claim 1, wherein the employer application comprises a mobile application.

20. The platform of claim 1, wherein the individuals have cleared a background check.

21. A computer-implemented system comprising:
a. a digital processing device comprising an operating system configured to perform executable instructions and a memory;
b. a computer program including instructions executable by the digital processing device to create an individual temporary staffing application comprising:
i. a software module configured to provide an interface allowing an individual to create an individual staff profile, the individual staff profile comprising a first plurality of scaled ratings on a scale with more than two rating levels by previous employers, and one or more of work experience, picture, video, qualifications, and billing rate;
ii. a software module configured to provide an interface allowing the individual to indicate availability for temporary staffing assignments, the availability comprising available dates, and for each date, available times;
iii. a software module configured to provide an interface allowing the individual to rate employers who have previously hired them for a temporary staffing assignment, wherein the rating is scaled, and wherein the scale comprises more than two rating levels;
iv. a software module configured to: provide an automatic and real-time notification to the individual in the individual temporary staffing application when they have been matched and selected for a current temporary staffing assignment; and receive a response to the notification from the individual, the response confirming an immediate booking for the current temporary staffing assignment; and
v. a software module configured to conduct an audio or video interview directly with a matched individual in the individual staffing application, wherein the audio or video interview is conducted live, directly between the employer and the matched individual;
provided that the individual is automatically selected for the temporary staffing assignment based on experience, qualifications, billing rate, availability, the first plurality of scaled ratings of the individual by previous employers, and a second plurality of scaled ratings of previous employers by the individual.

22. A computer-implemented system comprising:
a. a digital processing device comprising an operating system configured to perform executable instructions and a memory;
b. a computer program including instructions executable by the digital processing device to create an electronic employer temporary staffing application comprising:
i. a software module configured to provide an interface allowing an employer to create an employer profile, the employer profile comprising a plurality of scaled ratings on a scale with more than two rating levels by individual staff previously employed, and one or more descriptions of temporary staffing assignments, type of business, url, address, phone number, dress code for assignment, number of employees, owner name, and supervisor;
ii. a software module configured to provide an interface allowing the employer to rate individuals who have previously performed temporary staffing assignments, wherein the rating is scaled, and wherein the scale comprises more than two rating levels;
iii. a software module configured to provide an interface allowing the employer to perform a targeted search for individuals suitable for a current temporary staffing assignment;
iv. a software module configured to automatically match one or more individuals to the current temporary staffing assignment based on individual experience, qualifications, billing rate, availability, a second plurality of scaled ratings of the individual by previous employers, and the plurality of scaled ratings of previous employers by the individual;
v. a software module configured to provide an interface allowing the employer to immediately book a matched individual in the employer temporary staffing application, the matching and booking generating an automatic and real-time notification to the individual in the employer temporary staffing application; and
vi. a software module configured to conduct an audio or video interview directly with a matched individual in the employer temporary staffing application, wherein the audio or video interview is conducted live, directly between the employer and the matched individual.

23. A computer-implemented method of booking an individual for an electronic temporary staffing assignment comprising:
a. storing, by a computer, an employer profile comprising a first plurality of scaled ratings by individual staff previously employed for temporary staffing assignments by the employer, wherein the scale comprises more than two rating levels;
b. storing, by the computer, a plurality of individual staff profiles each comprising a second plurality of scaled ratings of the individual by previous employers;
c. receiving, by the computer, a request by the employer to fill a current temporary staffing assignment;
d. matching, by the computer, one or more individuals to the current temporary staffing assignment based on individual experience, qualifications, billing rate, availability, the second plurality of scaled ratings of the individual by previous employers, and the first plurality of scaled ratings of previous employers by the individual;
e. transmitting, by the computer, an automatic and real-time notification to a matched individual within a temporary staffing system when they have been matched to the current temporary staffing assignment, and selected for the current temporary staffing assignment;
f. receiving, by the computer, a response to the notification, the response triggering an immediate booking of the individual for the current temporary staffing assignment; and
g. providing, by the computer, an interface for conducting an audio or video interview directly within the temporary staffing system, wherein the audio or video interview is conducted live, directly between the employer and the matched individual.
